(19) United States
(12) Patent Application Publication
(10) Pub. No.: US 2005/0095563 A1
(43) Pub. Date: May 5, 2005

(54) Apparatus, system and a method for simulating jet propulsion travel

(76) Inventor: Bradley Engstrand, Hartford, WI (US)

Correspondence Address: PATENTS+TMS;A Professional Corporation, 1914 North Milwaukee Avenue, Chicago, IL, 60647, US

(21) Appl. No.: 10/701,136

(22) Filed: Nov. 4, 2003

(51) Int. Cl. G09B 9/08; G09B 19/16

(52) U.S. Cl. 434/37

(57) ABSTRACT

An apparatus, a system and a method for simulating jet propulsion travel are provided. The apparatus may have a monitor, or other display device, connected to a frame. A seat may also be connected to the frame on which a user may sit. The monitor may provide images simulating jet propulsion travel, such as, for example, a view that the user may have if traveling by means of a jet propulsion pack. The seat may move in one or more directions; as a result, the user may experience a feeling of instability similar to that experienced during actual jet propulsion travel.

### BACKGROUND OF THE INVENTION

The present invention generally relates to an apparatus, a system and a method for providing a virtual reality display to a user. More specifically, the present invention relates to an apparatus, a system and a method for simulating jet propulsion travel. The user may view a video display while using the apparatus. The video display may present images simulating movement by the user which may be experienced during jet propulsion travel. The apparatus may have a seat and/or bars connected to the seat on which the user may support himself/herself. The seat and/or bars may move, allowing the user to move, providing a simulation to the user of movement during the jet propulsion travel.

It is, of course, known to provide a virtual reality display. A user may, for example, wear a headset which has a screen. A display may be provided on the screen, such as, for example, graphic images, such as those displayed in video games. In other systems, the display may be video images. The user may view the display while, for example, sitting in a chair. The images may simulate motion; however, the user himself does not experience any movement as the images are being displayed.

For example, the user may view a display in, for example, a headset. The display may simulate motion, such as, for example, riding in an automobile. Graphical images may be provided in the display to provide a view to the user as if she is seated in the automobile. The graphical images may change to, for example, simulate swerving of the automobile. As a result, the user may feel as if she is within the automobile.

In other systems, the chair or seat in which the user is sitting provides a vibration or other movement. In the above example, the user may be seated in a chair which, for example, moves the user when images simulating swerving of the automobile are displayed.

However, in known systems, the movement of the chair or other device may be limited in range of motion. As a result, the system may not provide the user with a sensation which is comparable to the actual motion or activity simulated. Moreover, a subject matter of the images displayed may be limited to, for example, merely driving an automobile or other vehicle. Accordingly, the user may experience only a limited variety of simulated motions and/or activities.

A need, therefore, exists for an apparatus, a system and a method for simulating jet propulsion travel which may provide the user with a realistic simulation of jet propulsion travel.

### SUMMARY OF THE INVENTION

The present invention provides an apparatus, a system and a method for simulating jet propulsion travel. The apparatus may have a frame having a seat on which a user may sit. The seat may be adjusted to move in one or more directions. Bars or handles may be connected to the frame to allow the user to support himself. A video display may be provided by, for example, a headset having a screen. Images simulating jet propulsion travel may be displayed as the seat is moved by the user and/or the system. As a result, the user may experience an accurate simulation of jet propulsion travel.

To this end, in an embodiment of the present invention, an apparatus is provided for simulating jet propulsion travel. The apparatus has a frame having a base. The apparatus also has a stand attached to the base. A seat is attached to the stand wherein the seat is movable. The apparatus also has a display means attached to the frame wherein the display means provides an image of the jet propulsion travel.

In an embodiment, the apparatus has a vibration motor attached to the frame wherein the vibration motor causes the frame to resonate.

In an embodiment, the apparatus has handles attached to the frame.

In an embodiment, the apparatus has speakers connected to the display means.

In an embodiment, the apparatus has an olfactory system attached to the frame wherein the olfactory system stores a scent which is emittable.

In an embodiment, the apparatus has a central processing unit connected to the display means.

In an embodiment, the apparatus has a memory connected to the display means wherein the memory stores the image of the jet propulsion travel.

In an embodiment, the apparatus has an audio memory connected to the display means wherein the audio memory stores sounds associated with jet propulsion travel.

In another embodiment of the present invention, a system is provided for simulating jet propulsion travel. The system has a seat and a vibration motor fastened to the seat. The system also has a central processing unit connected to the vibration motor. Further, the system has display means adjacent to the seat and connected to the central processing unit. In addition, the system has a memory connected to the central processing unit wherein the memory stores images of jet propulsion travel and further wherein the central processing unit transmits a signal causing the vibration motor to vibrate when the images are displayed on the display means.

In an embodiment, the system has a frame attached to the seat wherein the display means is attached to the frame.

In an embodiment, the system has an audio memory connected to the central processing unit wherein the audio memory stores sounds associated with the jet propulsion travel.

In an embodiment, the system has an olfactory system connected to the central processing unit wherein the olfactory system stores a scent.

In an embodiment, the system has a power source connected to the vibration motor.

In an embodiment, the system has speakers connected to the display means wherein the speakers emit sounds when the images are displayed.

In an embodiment, the system has a spring attached to the seat.

In an embodiment, the system has input means connected to the central processing unit wherein the input means control the display of the images on the display means.

In an embodiment, the system has an atomizer adjacent to the display means wherein the atomizer emits a scent.

In another embodiment of the present invention, a method is provided for simulating jet propulsion travel. The method comprises the steps of: displaying a first image of the jet propulsion travel to the user; emitting a sound when the first image is displayed; and vibrating a seat when the first image of the jet propulsion travel is displayed.

In an embodiment, the method further has the step of displaying a second image of jet propulsion travel in response to a movement by the user wherein the second image is different from the first image.

In an embodiment, the method further has the step of emitting a scent when the first image is displayed.

It is, therefore, an advantage of the present invention to provide an apparatus, a system and a method for simulating jet propulsion travel.

Another advantage of the present invention is to provide an apparatus, a system and a method for simulating jet propulsion travel wherein the apparatus has a seat which may assist in simulation of jet propulsion travel by the user.

Yet another advantage of the present invention is to provide an apparatus, a system and a method for simulating jet propulsion travel wherein the system has a display which may provide images, such as, for example, video images, graphic images, and/or the like.

And, another advantage of the present invention is to provide an apparatus, a system and a method for simulating jet propulsion travel wherein the system has a sound system.

A still further advantage of the present invention is to provide an apparatus, a system and a method for simulating jet propulsion travel which may have a vibration motor to actuate movement of a seat.

Moreover, an advantage of the present invention is to provide an apparatus, a system and a method for simulating jet propulsion travel which may have an olfactory system which may provide scents to a user to simulate jet propulsion travel.

Additional features and advantages of the present invention are described in, and will be apparent from, the detailed description of the presently preferred embodiments and from the drawings.

### BRIEF DESCRIPTION OF THE DRAWINGS

FIG. 1 illustrates a block diagram of a system in an embodiment of the present invention.

FIG. 2 illustrates a perspective view of a system for simulating jet propulsion travel in an embodiment of the present invention.

FIG. 3 illustrates a perspective view of a user sitting in a system for simulating jet propulsion travel in an embodiment of the present invention.

### DETAILED DESCRIPTION OF THE PRESENTLY PREFERRED EMBODIMENTS

The present invention generally relates to an apparatus, a system and a method for simulating jet propulsion travel. The apparatus may have a frame having a seat on which a user may sit. A display means may be adjacent to the frame and may have, for example, a screen providing a video display. Bars, or handles, may be connected to the frame to assist the user in supporting himself/herself. The seat may be supported by, for example, a spring, causing the seat to pivot in one or more directions. Images simulating jet propulsion travel may be displayed on the screen as the seat is moved by the user and/or the system. The user may then experience a simulation of jet propulsion travel.

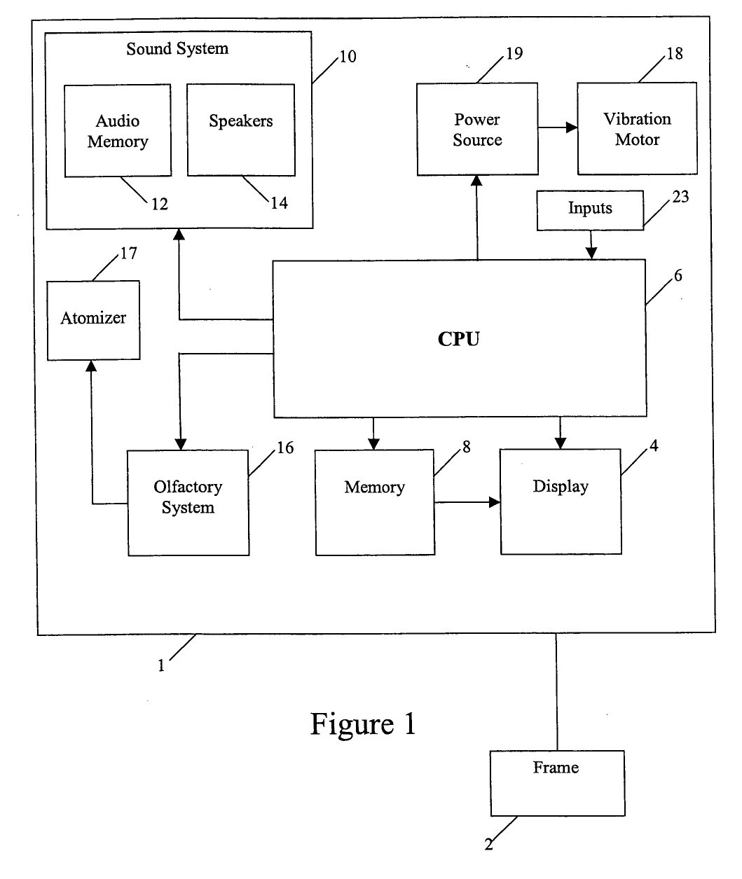

Referring now to the drawings wherein like numerals refer to like parts, FIG. 1 illustrates a box diagram of a system 1 for simulating jet propulsion travel. The system 1 may have a frame 2 upon which a user may sit, for example, when experiencing the simulation. A display 4 may be provided adjacent to the frame 2. The display 4 may be, for example, a screen, a monitor, a collimated mirror arrangement, or the like. The display 4 may be connected to a central processing unit 6 which may store an operating system enabling simulation of jet propulsion travel. The central processing unit may be at a location remote from the frame 2. A memory 8 may be connected to the central processing unit 6 and may be located remote from the frame 2. The memory 8 may contain images simulating jet propulsion travel by a user. The images may be in the form of, for example, graphic images, video images, or the like. The images may be transferred from the memory 8 to the display 4 based on commands received from the central processing unit 6.

The system 1 may also have a sound system 10 in connection with the central processing unit 6. The sound system 10 may have, for example, an audio memory 12 having sounds for simulating jet propulsion travel, such as sounds simulating wind, a sound of a booster from a jet pack, or verbal instructions for the user, for example. The sounds may be in digital form, such as, for example, .wav files, .mp3 files or the like. The audio memory may also contain, for example, music which may be in digital and/or analog form. The audio memory 12 may be located remote from the frame 2.

The sound system 10 may also have speakers 14 in connection with the audio memory 12 to present the sounds and/or music to the user. The speakers 14 may be adjacent to the display 4. Moreover, the speakers 14 may be located at various points along the frame 2 to surround the user with the sounds and/or music associated with jet propulsion travel.

An olfactory system 16 may also be connected to the central processing unit 6. The olfactory system 16 may store various scents in, for example, gaseous or liquid form. The scents may be stored in, for example, individual containers. The olfactory system 16 may be located remote from the frame 2. In addition, the olfactory system 16 may be connected to an atomizer 17 which may dispense the scents. The atomizer 17 may be connected to each of the containers by, for example, valves which may enable only a selected scent to be transmitted to the atomizer 17. Commands from the central processing unit 6 may cause the atomizer 17 to expel one or more of the scents stored within the olfactory system 16. One or more atomizers 17 may be positioned on the frame 2 adjacent to, for example, the display 4. A scent stored within the olfactory system 16 may be selected by the central processing unit 6 to be projected toward the user. The selected scent may correspond with an image or sound presented to the user during the simulation. For example, if the display 4 provides images of jet propulsion travel along an oceanfront, the central processing unit 6 may select a scent from the olfactory system 16 similar to those emanating from an actual oceanfront. The central processing unit 6 may then send a command to the olfactory system 16 wherein the atomizer 17 may emit the selected scent toward the user during the simulation.

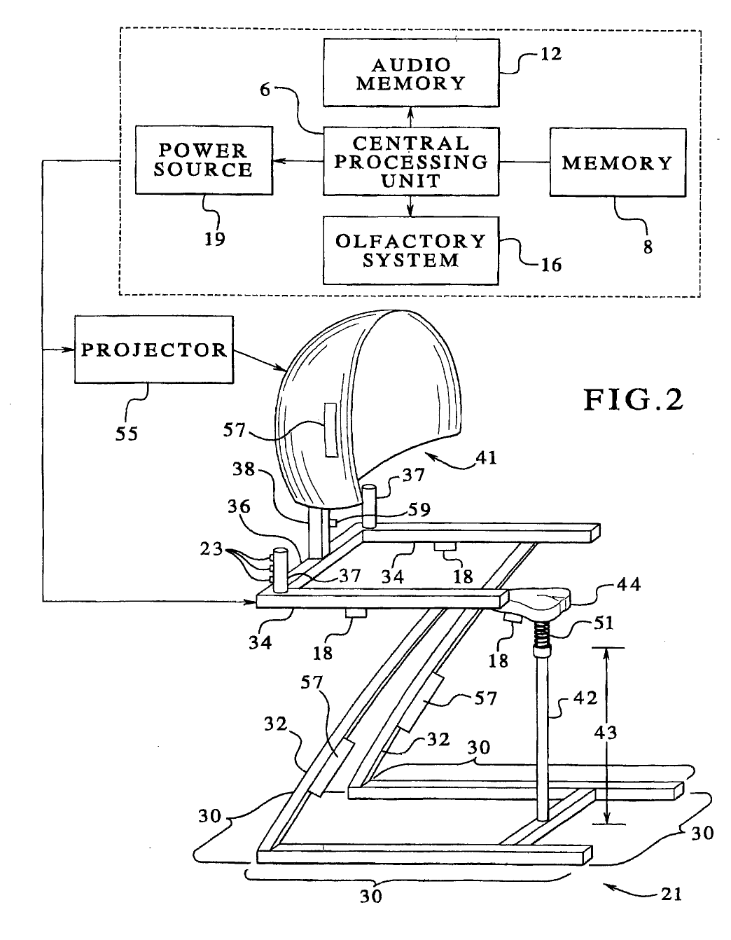

One or more vibration motors 18 may be connected to the frame 2 at various points along the frame 2. The vibration motors 18 may be contained within, for example, a housing, as illustrated in FIG. 2. The vibration motors 18 may be of a type demonstrated in, for example, cellular phones, joysticks or the like. The vibration motors 18 may, for example, resonate, oscillate, vibrate, or perform any like motion when receiving electric current. Moreover, the vibration motors 18 may oscillate at an intensity which may cause resonation throughout the frame 2. The vibration motors 18 may connect to a power source 19 connected to the central processing unit 6. The power source 19 may be located remote from the frame 2. The central processing unit 6 may be programmed to transmit signals to the power source 19 to stimulate the vibration motors 18. Oscillations from the vibration motors 18 may occur in association with the images presented by the display 4 and/or sounds and/or music presented by the speakers 14.

FIG. 2 illustrates a frame 21 having a base 30 which may be rectangular in shape. In other embodiments, the base 30 may be, for example, circular, triangular, or any other shape which may provide support for the frame 21 and/or enclose the user. The base 30 may be constructed from, for example, wood, metal, plastic, or the like. Columns 32 may be attached to the base 30 and may be connected to bars 34 which the user may hold to support a position of the user during a simulation of jet propulsion travel. The bars 34 may be connected to handles 37 which may be held by the user during the simulation. The vibration motors 18 may also be attached to the handles 37. In an embodiment, the handles 37 may contain inputs 23, such as, for example, buttons, levers, or the like, which may be connected to the central processing unit 6. The inputs 23 may enable the user to control the images and/or sounds and/or music provided during the simulation.

A stand 42 may be connected to the base 30. The stand 42 may support a seat 44. In an embodiment, the stand 42 may have a length 43 which may be adjusted to a length wherein the user, when sitting on the seat 44, may be unable to contact a ground underneath the base 30 with, for example, his feet. As a result, the user may experience a physical sensation, such as, for example, a feeling of imbalance or instability while seated and may need to, for example, grasp the handles 37 to maintain balance or stability.

In an embodiment, a spring 51 may be positioned between the seat 44 and the stand 42. The spring 51 may bend, for example, in any direction in which the user may lean while seated. Accordingly, the spring 51 may assist in providing the user a perception of imbalance or instability. In other embodiments, the seat 44 may be connected to the stand 42 by any mechanism which may allow movement, such as, for example, a pivoting movement, of the seat 44. In an embodiment, one or more of the vibration motors 18 may be positioned underneath the seat 44. The vibration motors 18 may oscillate, causing resonance throughout the seat 44.

The bars 34 may be connected by a crossbar 36. A stand 38 may be attached to the crossbar 36 and may support the display 41. FIG. 2 illustrates the display 41 as a backdrop or screen. A projector 55 may transmit images onto the screen. However, in other embodiments, the display 41 may be, for example, a monitor or the like. In an embodiment, the display 41 may be sized larger than a head of the user to provide a peripheral view to the user of jet propulsion images. The speakers 57 and/or the atomizer 59 may be located adjacent to the display 41. Moreover, the base 30, the columns 32, the bars 34, the crossbar 36, or any other part of the frame 21 may contain wiring enabling connection of the display 41, the speakers 57 and the atomizer 59 to the central processing unit 6, the audio memory 12 and the olfactory system 16, respectively.

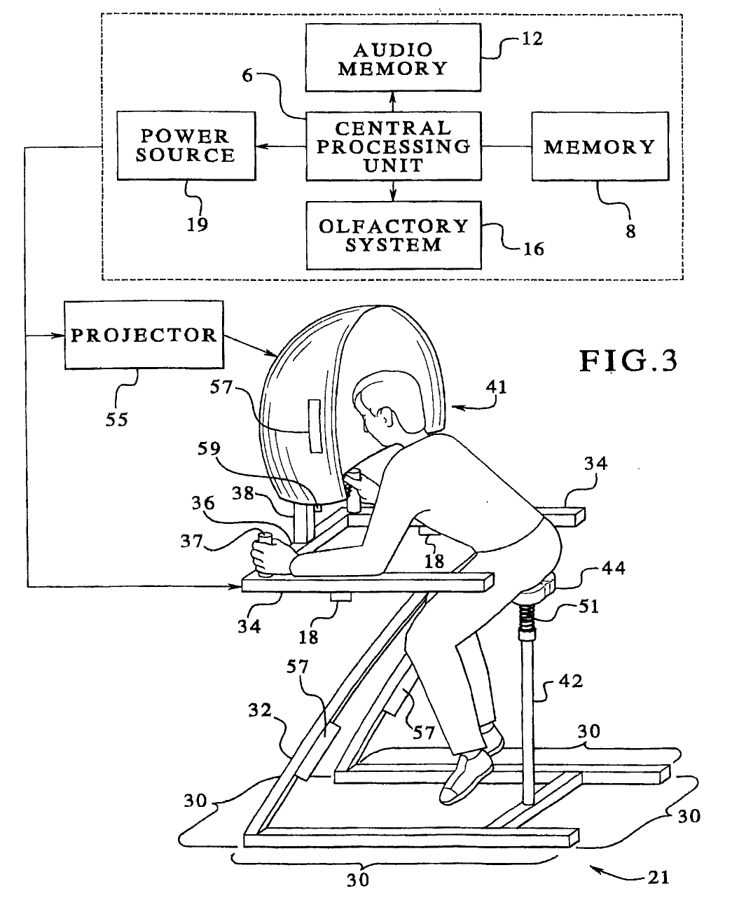

To begin the simulation of jet propulsion travel, the user may sit on the seat 44 and may grasp the handles 37, as illustrated in FIG. 3. The user may actuate the inputs 23 within the handles to send a command to the central processing unit 6 to begin the simulation. The central processing unit 6 may then transmit a signal to the memory 8 to transmit images to the display 41 for viewing by the user. The images may be instructions, for example, for using the inputs 23 during the simulation. The inputs 23 may represent control functions for a jet propulsion device. The images provided by the display 41 may simulate movement by the user when, for example, the jet propulsion device is activated and provides a thrust or lifting force. The images may also simulate movement by the user when, for example, the jet propulsion device is deactivated and does not provide a thrust or lifting force.

The central processing unit 6 may also transmit a signal to the sound system 10 to provide sounds and/or music to the user. The sounds and/or music may correspond to the images displayed. For example, the user may activate one of the inputs 23 which corresponds to activation of the jet propulsion pack. The central processing unit 6, in communication with the memory 8, may transmit a signal to the sound system 10 to emit a sound similar to a sound of an actual jet propulsion pack providing thrust to lift a user. Moreover, the sounds and/or music provided by the sound system 10 may change in relation to the images provided by the display 41. For example, the display 41 may provide images simulating airborne travel by the user from a first point to a second point. Simultaneously, the sound system 10 may emit sounds such as, for example, wind passing by the user, or thrust from a booster in the jet propulsion pack. The sound system 10 may also emit instructions to the user for, for example, controlling the simulated jet propulsion pack or maintaining a position of a body of the user during the simulation.

Accordingly, during simulation, the user may sit in the seat 44 and may hold the bars 34 and/or the handles 37, for example, to maintain his balance and/or a body position. The central processing unit 6, in correspondence to the images displayed and/or sounds emitted, may transmit a signal to the power source to cause the vibration motors 18 to oscillate. The vibration motors 18 may then cause the seat 44 and/or the handles 37 to vibrate to simulate a force of wind contacting the user.

The seat 44 may be connected with the central processing unit 6 wherein movement of the seat 44 may be detected by the central processing unit 6. Movement of the seat 44 may be caused by the user leaning in any direction, such as, for example, forwards, backwards, or to a side. In response, the central processing unit 6 may transmit a signal to the memory 8 to change the images provided on the display 41 to correspond with the position of the user. The central processing unit 6 may also transmit a signal to the sound system 10 to change a sound emitted from the speakers 57. Further, the central processing unit 6 may transmit a signal to effect oscillations of one or more vibration motors 18. In addition, the central processing unit 6 may transmit a signal to the olfactory system 16 to provide a scent to the user corresponding to the image displayed.

The system 1 of the present invention may provide the user with a simulation of jet propulsion travel by stimulating various senses of the user. To this end, the mobility of the seat 44 may cause the user to experience movement similar to that of a body which is airborne and/or subject to thrust forces from, for example, a jet booster. The sound system 10 may provide the user with sounds encountered during jet propulsion travel, such as, for example, wind passing by the user, the sound of a jet booster, or the like. Further, the olfactory system 16 may provide scents to the user which may correspond to the images provided on the display 4.

It should be understood that various changes and modifications to the presently preferred embodiments described herein will be apparent to those skilled in the art. Such changes and modifications may be made without departing from the spirit and scope of the present invention and without diminishing its attendant advantages.

1. An apparatus for simulating jet propulsion travel, the apparatus comprising:
a frame having a base;
a stand attached to the base;
a seat attached to the stand wherein the seat is movable; and
a display means attached to the frame wherein the display means provides an image of the jet propulsion travel.

2. The apparatus of claim 1 further comprising:
a vibration motor attached to the frame wherein the vibration motor causes the frame to resonate.

3. The apparatus of claim 1 further comprising:
handles attached to the frame.

4. The apparatus of claim 1 further comprising:
speakers connected to the display means.

5. The apparatus of claim 1 further comprising:
an olfactory system attached to the frame wherein the olfactory system stores a scent which is emittable.

6. The apparatus of claim 1 further comprising:
a central processing unit connected to the display means.

7. The apparatus of claim 1 further comprising:
a memory connected to the display means wherein the memory stores the image of the jet propulsion travel.

8. The apparatus of claim 1 further comprising:
an audio memory connected to the display means wherein the audio memory stores sounds associated with jet propulsion travel.

9. A system for simulating jet propulsion travel, the system comprising:
a seat;
a vibration motor fastened to the seat;
a central processing unit connected to the vibration motor;
display means adjacent to the seat and connected to the central processing unit; and
a memory connected to the central processing unit wherein the memory stores images of jet propulsion travel and further wherein the central processing unit transmits a signal causing the vibration motor to vibrate when the images are displayed on the display means.

10. The system of claim 9 further comprising:
a frame attached to the seat wherein the display means is attached to the frame.

11. The system of claim 9 further comprising:
an audio memory connected to the central processing unit wherein the audio memory stores sounds associated with the jet propulsion travel.

12. The system of claim 9 further comprising:
an olfactory system connected to the central processing unit wherein the olfactory system stores a scent.

13. The system of claim 9 further comprising:
a power source connected to the vibration motor.

14. The system of claim 9 further comprising:
speakers connected to the display means wherein the speakers emit sounds when the images are displayed.

15. The system of claim 9 further comprising:
a spring attached to the seat.

16. The system of claim 9 further comprising:
input means connected to the central processing unit wherein the input means control the display of the images on the display means.

17. The system of claim 9 further comprising:
an atomizer adjacent to the display means wherein the atomizer emits a scent.

18. A method for simulating jet propulsion travel for a user, the method comprising the steps of:
displaying a first image of the jet propulsion travel to the user;
emitting a sound when the first image is displayed; and
vibrating a seat when the first image of the jet propulsion travel is displayed.

19. The method of claim 18 further comprising the step of:
displaying a second image of jet propulsion travel in response to a movement by the user wherein the second image is different from the first image.

20. The method of claim 18 further comprising the step of:
emitting a scent when the first image is displayed.
